(19) United States
(12) Patent Application Publication
(10) Pub. No.: US 2008/0121310 A1
(43) Pub. Date: May 29, 2008

(54) Joint Making Jig

(76) Inventor: Kenneth M. Grisley, Port Coquitlam, CA (US)

Correspondence Address: JOHN S. PRATT, ESQ;KILPATRICK STOCKTON, LLP, 1100 PEACHTREE STREET, ATLANTA, GA, 30309, US

(21) Appl. No.: 11/942,076

(22) Filed: Nov. 19, 2007

Related U.S. Application Data
(60) Provisional application No. 60/860,167, filed on Nov. 20, 2006.

(51) Int. Cl. B27C 5/00

(52) U.S. Cl. 144/144.51; 144/144.1

(57) ABSTRACT

Repositionable guide joint-making jig and spacer and stop components capable of producing both variably spaced, variable width joints and “machine-made” style joints.

### RELATED APPLICATIONS

This application claims the benefit of U.S. Provisional Application Ser. No. 60/860,167, filed Nov. 20, 2006 for “Various Attachments and Accessories for Use with Cutting Templates and Methods for Using the Same,” the entire contents of which are hereby incorporated by this reference.

### RELATED FIELDS

This invention relates to jigs and devices to facilitate making woodworking joints, particularly including dovetail and box joints, utilizing a router.

### BACKGROUND

Dovetailing jigs and other devices to facilitate making woodworking dovetail, box and other joints are well known. The earlier such devices for small woodworking shop use utilized a comb-like plate with a series of side-by-side grooves that guide movement of an electric router. Such devices are exemplified by McCord, Jr., U.S. Pat. Nos. 3,800,840 and 3,834,435, which are incorporated herein by reference. Such devices can be utilized to shape both the pin and tail members of a dovetail joint simultaneously. However, the joint so produced has a distinctly “machine-made” appearance that generally is not considered to be as desirable as the appearance of “hand-cut” or variably spaced dovetail joints. Accordingly, a significant advance occurred with the invention of the Leigh Industries dovetailing jigs covered by Grisley U.S. Pat. No. 4,428,408, which is incorporated by reference.

In the Leigh Industries jigs, opposite ends of repositionable guides mounted in a jig assembly to guide an electric router are used to cut the two members of a dovetail joint. This jig permits the production of dovetail joints having variable pin and tail spacing and dimensions, facilitating production of joints with the appearance of traditional hand-cut joints. Other repositionable guide dovetail jigs are on the market, including the apparatus disclosed in Hampton U.S. Pat. No. 6,116,303 and the Akeda jig. Some of such jigs use guides that use only one finger to guide formation of predetermined width pins, while other jigs use “split-finger” guides usable to form tails of different widths.

However, the user of a repositionable guide dovetail joint jig will occasionally desire to make dovetail joints in the form and having the appearance of “machine-made” joints like those produced with the McCord, Jr. type of jig depicted in the McCord, Jr. patents identified above.

### SUMMARY

This invention has multiple embodiments, configuration, capabilities and benefits. Among other things it enables a repositionable guide joint-making jig to be used to produce “machine-made” style joints, cutting both the pins and tails simultaneously.

Provided that the repositionable guides of variable spacing “Leigh Industries” type joint-making jigs can be positioned so that pins are produced having pin width equal to pin to pin spacing, such a repositionable guide jig can be configured to produce the pin and tail widths and spaces between pins and tails necessary to replicate a “machine-made” dovetail joint. However, typical Leigh Industries and similar jigs contemplate use in which the router cutter passes entirely through the work-piece in which joint members are being formed. Moreover, such jigs are normally designed to accommodate a range of different work-piece thicknesses. As a result of these jig capabilities, the fingers of the guides are typically too long to use the guide to form “machine-made” style joints cutting both pins and tails simultaneously with a single pass of the router cutter, because location of the guides to cut half blind pins of correct depth will result in tails of incorrect thickness.

Provision of means for simultaneous reduction in the working length of all fingers of adjustable guides mounted in a jig can enable the jig to be used to produce dovetail joints having a “machine-made” appearance. Reduction in the working length of each of multiple fingers can be achieved by placing spacer blocks in the recess of each guide or by otherwise positioning structure that a router bushing or the guide bearing of a router cutter will encounter, thereby stopping advance of the cutter into the work-piece. This can also be achieved by positioning a rod in side-by-side fingers that are penetrated laterally with suitably positioned and sized rod-receiving holes. Such a rod can be more easily inserted in some instances when the rod is flexible.

Simultaneous formation of both halves of a “machine-made” style joint requires that the joint members be offset by one-half the width of one joint tail or pin element. This offset can be seen at 5 in FIG. 1. Such an offset can be readily accomplished in a Leigh Industries type jig using an appropriate width spacer temporarily (but preferably firmly) fixed in position to provide a work-piece registration surface.

### BRIEF DESCRIPTION OF THE DRAWINGS

FIG. 1 is a perspective view of a prior art comb-type dovetail jig that produces “machine-made” style dovetail joints that are cut simultaneously in the pin and tail boards positioned in the jig as depicted.

FIG. 2 is a perspective view of the left side of one embodiment of the dovetail jig of this invention configured to cut “machine-made” style dovetail joint pins and tails simultaneously.

FIG. 3 is a perspective view of one of the guides shown in the dovetail jig of FIG. 2 with lateral holes 14 readily visible.

FIG. 4 is an enlarged view of the portion of FIG. 2 within the circle “4.”

FIG. 5 is close-up of the left side of the jig in FIG. 2 showing a spacer stored.

FIG. 6 is a perspective view showing a first side of a multifunctional spacer of this invention.

FIG. 7 is a perspective view showing a second side of the spacer depicted in FIG. 6.

FIG. 8 is a view of portions of the jig shown in FIG. 2 and depicting use of a spacer to position guides on the jig.

FIG. 9 is a perspective view of one side of an alternative embodiment of a multi-functional spacer.

FIG. 10 is a perspective view of the other side of the multi-functional spacer shown in FIG. 9.

FIG. 11 is a perspective view of the an embodiment of the spacer of this invention shown exploded away from a jig component to which it attaches.

### DETAILED DESCRIPTION

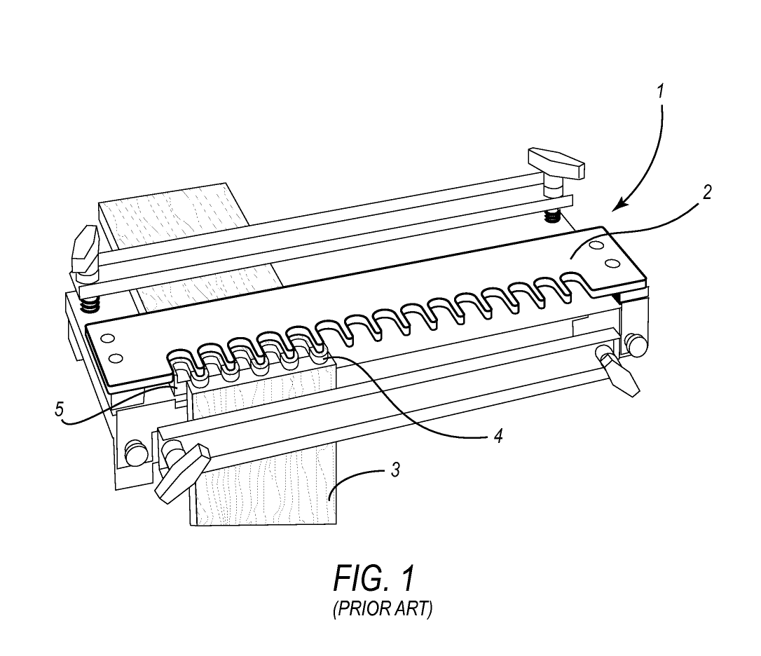

A typical fixed template comb-type dovetail jig 1 of the sort illustrated in FIG. 1 is dimensioned to be used with a drawer side 3 of a particular thickness, such as one-half inch (½″). It can be used with thicker drawer sides, although the tail thickness will remain unchanged, but such a jig 1 cannot be used with a drawer side 3 that is thinner than the predetermined tail thickness because there will be insufficient work-piece thickness to form complete tails.

Equal depth or thickness of pins and tails is required for proper joint fit in a half-blind “machine-made” style joint of the sort produced using prior art jig 1. Accordingly, the guide finger length will need to a little less than twice the depth or thickness of the tailboard. However, relatively long guide fingers are needed for variably spaced, through dovetails where the router cutter passes entirely through the thickness of the tail board. Accordingly, accommodation of a reasonable range of tail board thicknesses on a Leigh Industries type jig capable of use in making through dovetail joints requires that guide finger length be approximately 1⅛ inches or more. However, that finger length could be used to produce machine-type dovetails only in tailboards more than at least about 9/16 inches thick or greater, which is thicker than is often desired for drawer sides.

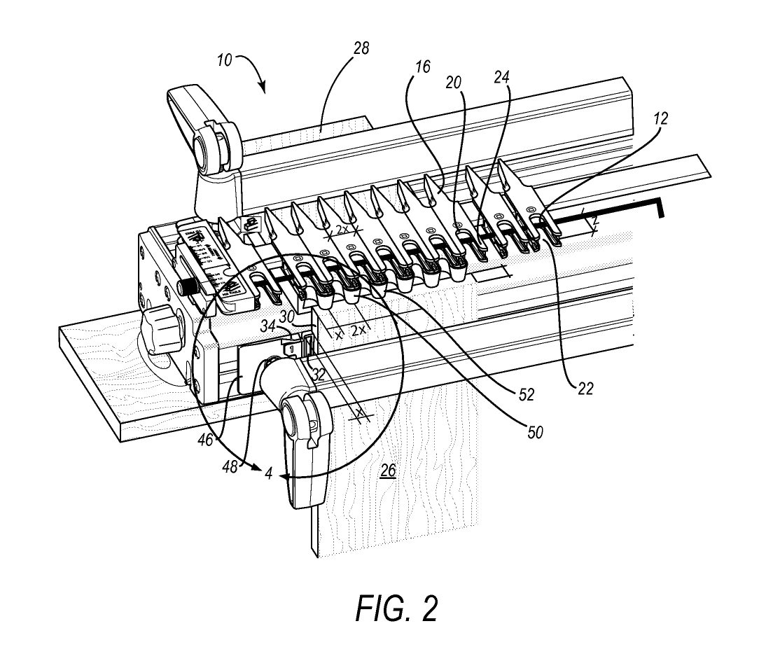

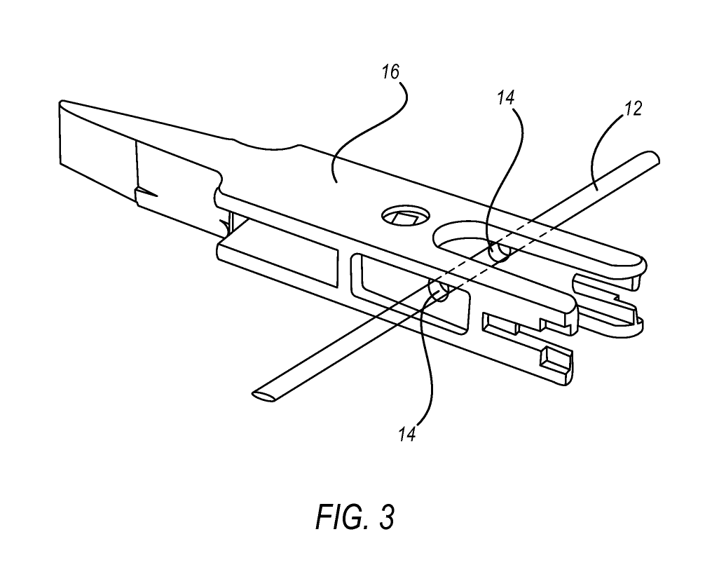

Accordingly, in order to produce “machine-made” joints using appropriately dimensioned variable spacing guide fingers 16 of the sort depicted in FIG. 2, it is necessary to shorten the effective working length of the guide fingers 16, which are relatively long in order to use them in cutting through dovetails. Such “shortening” can be achieved in an exemplary jig 10 of this invention, as is depicted in FIG. 2, by positioning a rod 12 in aligned lateral holes 14 in the guides 16. A router bit pilot bearing (not shown) or router bushing (not shown) will contact the rod 12 rather than the surface 20 deepest in the guide 16 recess 22, thereby effectively shortening the working length of the fingers 24 of guides 16. Such coaxial lateral holes 14 in guides 16 and positioning of rod 12 in those holes may be easily seen in the guide 16 depicted in FIG. 3.

Such a guide shortening rod 12 can be round, square or of virtually any other cross-sectional shape that will stop advance of a router bit into each guide 16 recess 22 at the same, correct location in each recess. Such a rod can likewise be made of steel, brass or any other material having suitable rigidity, strength, flexibility and other properties to insure that it will serve the intended function. Use of a plastic rod with some ability to bend will facilitate advancing the rod 12 into the guide holes 14 while the guides 16 are properly positioned within the jig 10, particularly when there is structure at one or both sides of the guide 16 holes 14 blocking coaxial access to the holes 14. Although other sizes and shapes are usable, a round rod approximately ⅛″ in diameter of plastic, such as nylon, polyvinyl chloride or any other material having adequate strength, flexibility, rigidity, durability and other properties may be used.

Correct positioning of the work-pieces relative to each other is also required for successful simultaneous cutting of both dovetail joint members 26 and 28. One member needs to be offset from the other by one-half the tail or pin width. Such an offset can be obtained with a spacer that offsets one joint member work-piece by the required distance relative to the second member.

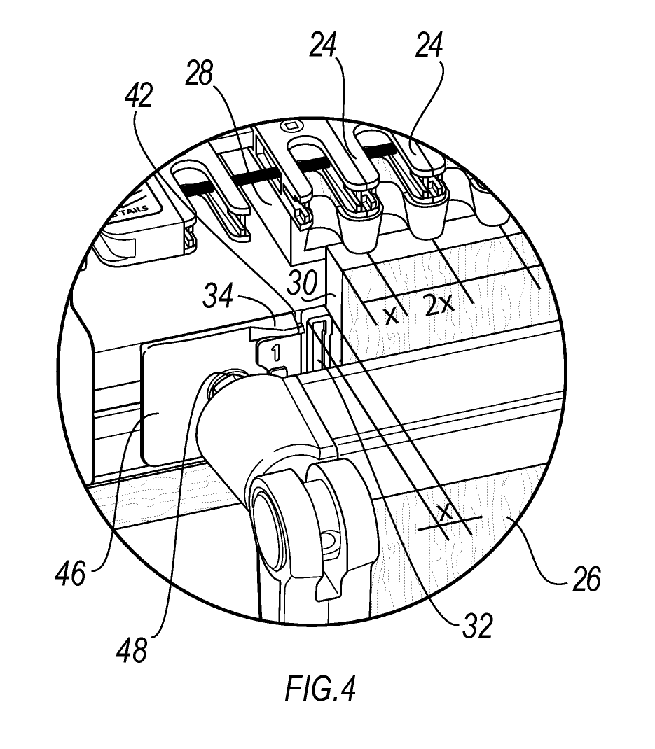

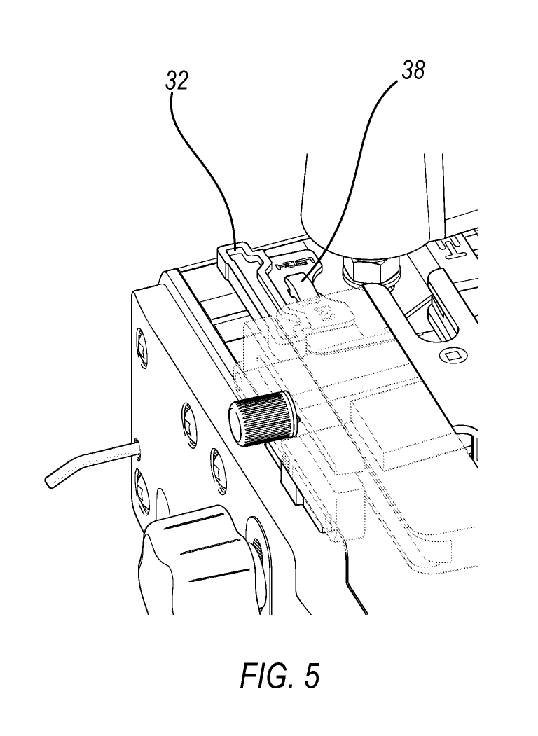

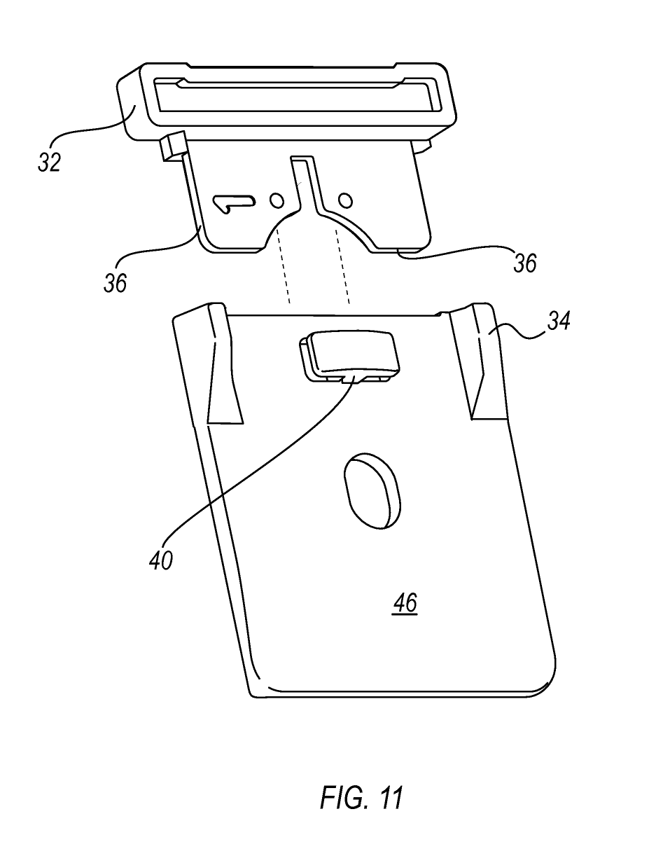

In the embodiment of this invention depicted in FIG. 2, such a spacer 32 is positioned between the side surface (against which spacer 32 is positioned) provided by jig member 34 and the side 30 of work-piece tail board 26. As depicted in FIG. 11, the spacer 32 can be positioned by sliding two spacer arms 36 around and under a post 40 adjacent to jig tail board side registration surface 42 (as shown best in FIG. 4). Registration of a work piece 26 against spacer 32 is depicted in FIG. 2. The same spacer 32 can be stored out of the way when not in use by forcing opposed spacer arms 36 around post 38 as depicted in FIG. 5.

As is indicated by the “2x” and “x” dimensions in FIGS. 2 and 4, and the “x” dimension in FIG. 7, the width of the offset, and therefore the width (x) of spacer 32 (with the numeral “1” visible) is one-half of the distance (2×) between like joint elements, e.g., joint elements (tails) 50 and 52. This width “x” provided by spacer 32 will offset tail board 26 from pin board 28 by one-half of the interval between like joint elements (e.g., between tails 50 and 52), thereby causing the edges of boards 26 and 28 to be aligned when the joint is assembled.

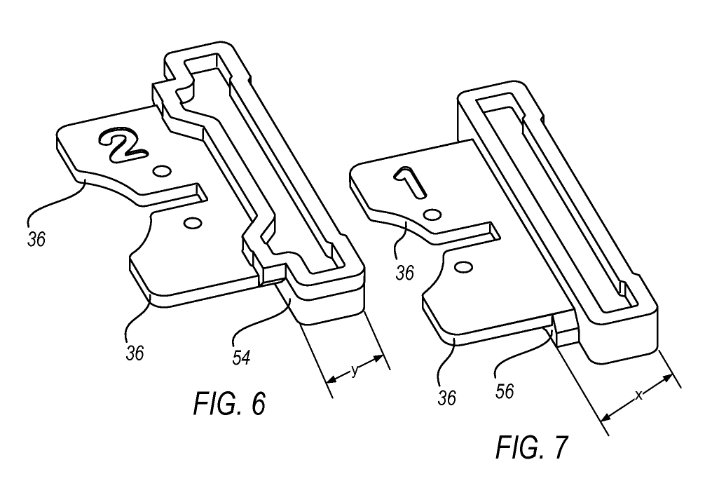

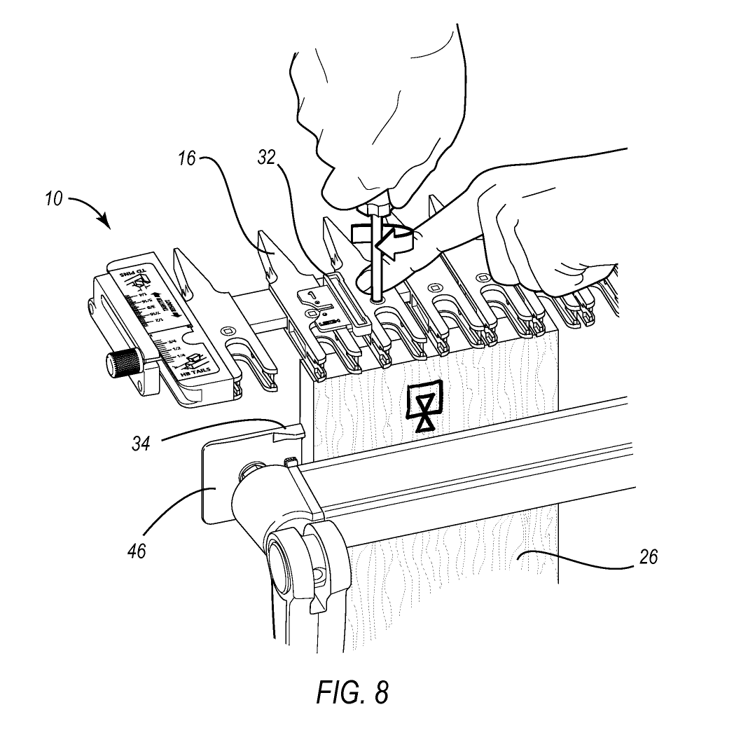

As can be best appreciated by comparison of FIGS. 6 and 7, spacer 32 is configured to present a spacer 32 work-piece registration surface offset from the registration surface of jig member 34 when spacer 32 is positioned with the numeral “2” visible. This difference results from spacer positioning with contact between spacer surface 56 when the spacer is positioned with the numeral “1” visible and with spacer positioning with contact between spacer surface 54 when the numeral “2” is visible. Although many different dimensions could be used, an exemplary pair of spacer dimensions might be “x”= 7/16″ and y= 5/16″. The distance “x” dimension of spacer 32 can also be used to locate guides 16 by spacing them apart distance “x” as shown in FIG. 8.

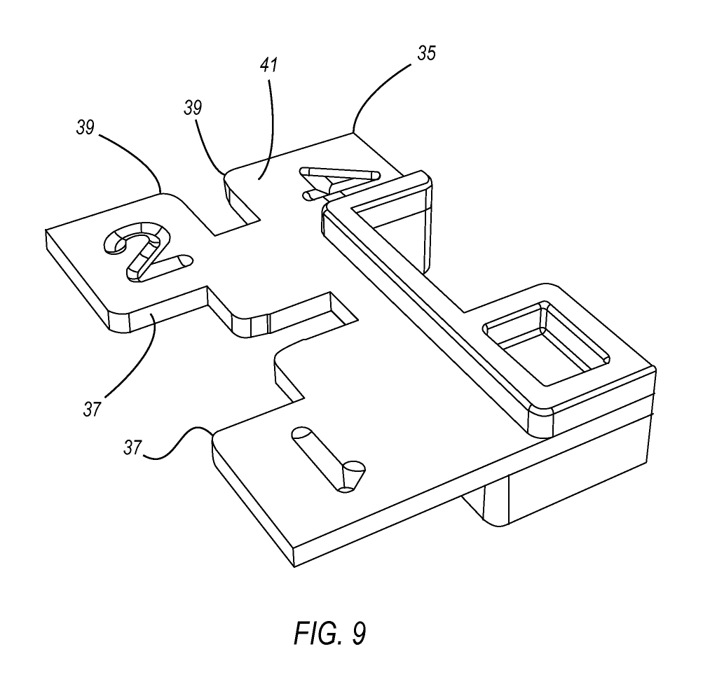

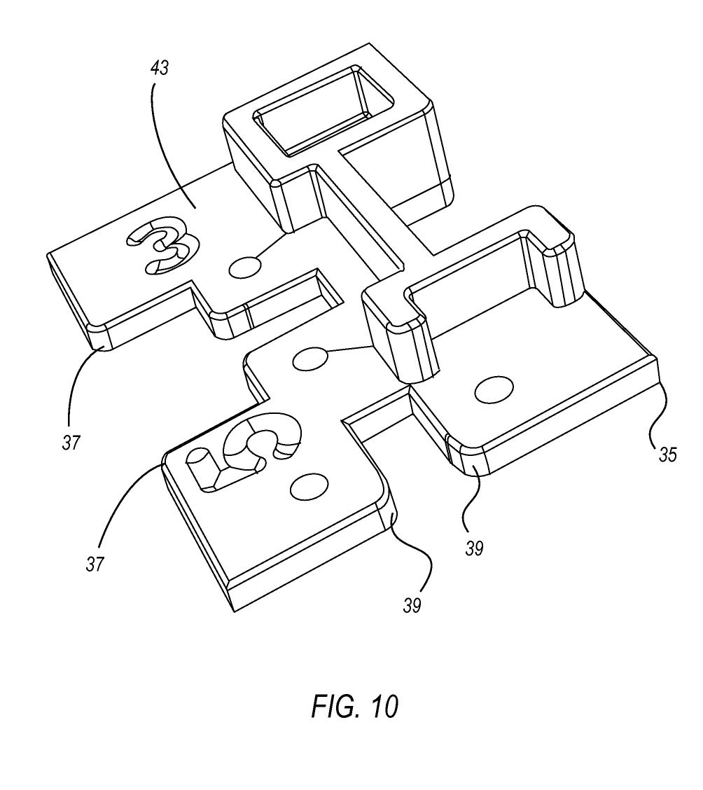

As is illustrated in FIGS. 9 and 10 an alternative embodiment 35 of the spacer of this invention could have five spacing distances or functions by utilizing two sets of arms 37 and 39. This spacer 35 can be used as illustrated in FIG. 8 to locate guides 16, or by alternatively positioning the spacer with arms 37 around post 40 and with the first side 41 or the second side 43 visible or with arms 39 around post 40 with either the first side 41 or the second side 43 visible.

Numerous other spacer structures could be used, including, for instance, a block of plastic substituted for but similar to stop 46 (FIG. 2) on the same threaded rod under nut 48 as stop 46 but with an off-center hole that presents an edge of the block 34 facing in a particular direction in different lateral positions by rotating in 90 degree increments and securing the block in different positions.

Those skilled in the art will recognize that numerous other modifications of the invention can be made without departing from the spirit of this invention and the merely exemplary embodiments described above or the scope of the following claims. For instance, structures other than the rods described above and depicted in the drawings can be used to shorten the effective working length of the guide 16 fingers 24. Individual stops that slip into the spacer between finger 24 could be provided or a laterally extending fence could be positioned to stop travel of the router and router cutter into the work-pieces and between guide fingers 24 by contact between the router base and the fence.

As described above, alternative means are also possible for laterally offsetting the work-pieces 26 and 28. A spacer could be used to move pin board 28 rather than tail board 26, and other alternatives are possible. For instance, as is depicted in FIGS. 9 and 10, a spacer 35 can be provided with more than three functions like that of spacer 32. Such a spacer 35 can be positioned on a post 40 as described above, but rather in more than two positions. Spacer 35 has two sets of arms 37 and 39 and two sides 41 and 43, resulting in four different positions on post 40 to provide four different amounts of joint offset.

1. A dovetail jig, comprising:
(a) movable guides positionable on a guide holder to guide a router to cut joint members on each of two work-pieces temporarily secured relative to the guides, wherein the work-pieces each have a length and a width, and the guides are positionable:
(1) in various different positions relative to each other to facilitate cutting joint members having differently spaced joints elements or joint elements narrower than the space between elements, or
(2) in equally spaced apart or abutting positions to facilitate cutting joint members on one of the two work-pieces equal in width to joint members on the other of the two work-pieces, and
(b) at least one stop removably positionable relative to the guides when they are equally spaced apart or abutting to limit movement of the router relative to at least one of the guides transverse to the width of the work-pieces.

2. The dovetail jig of claim 1, wherein the at least one stop comprises a rod removably positionable in holes in the guides.

3. The dovetail jig of claim 2, wherein the holder is attachable to a jig base and a hole in the base can receive and store the stop rod when not in use.

4. The dovetail jig of claim 1, further comprising:
(a) two registration surfaces for positioning the work-pieces relative to the guides, each of which registration surfaces are in the same plane, and one of which is for contact during jig use with each one of the two work-pieces when using the jig with the guides in the various positions, and
(b) a spacer having a first width for positioning between one of the registration surfaces and one of the work-pieces to offset the work-pieces from each other by the spacer width when using the jig with the guides in the equally spaced or abutting positions.

5. The dovetail jig of claim 4, wherein the width of the spacer and of the offset resulting from use of the spacer is one-half of the width of the equal-width joint elements when the guides are arranged to produce pin joint elements equal in width to tail joint elements so that joint pins on one work-piece and joint tails on the other work-piece will be aligned during their formation on the jig and joint pins will be received between joint tails when the two work-pieces are aligned with each other and joined.

6. The dovetail jig of claim 5, further comprising a post fixed proximate the first registration surface and wherein the spacer comprises two arms that removably secure the spacer to the post and in contact with the registration surface.

7. The dovetail jig of claim 6, further comprising a second post on the jig away from the registration surface for storing the spacer when not in use in contact with the registration surface.

8. The dovetail jig of claim 6, wherein the spacer snap fits in place with the arms on opposite sides of the post.

9. The dovetail jig claim 1, wherein the stop simultaneously limits router movement relative to all of the guides used during a particular operation.

10. The jig of claim 4, wherein the spacer has a second spacer width different from the first for off setting the work pieces by the spacer width.

11. A router jig, comprising:
(a) at least one guide having:
(1) a generally planar surface for contact with a bottom of a base of a router,
(2) two fingers defined at least in part by:
(i) portions of the planar surface and,
(ii) for contact with a router guide bushing or router bit guide bearing, a guide surface generally perpendicular to the planar surface and forming a u-shape having two parallel, spaced apart surfaces joined by a web to guide the router and stop advance of a router bit into a work-piece when the router guide bushing or router bit guide bearing contacts the web of the u-shaped surface, and
(b) a stop removably attached to the guide to provide a stop surface for contact with the router guide bushing or router bit guide bearing to stop advance of the router guide bushing or guide bearing before reaching the web.

12. The jig of claim 11, wherein the stop is a rod positioned in two aligned holes in the guide fingers, each one of which holes has a longitudinal axis parallel to the generally planar surface.

13. The jig of claim 12, further comprising a spacer to facilitate lateral positioning of work-pieces in the jig.

14. The jig of claim 13, wherein each guide has two parallel fingers on one end for guiding a router cutter when cutting dovetail joint tails, and one finger on the other end of the guide for guiding a router cutter when cutting dovetail joint tails.

15. The jig of claim 11, wherein the stop is a rod and at least one guide comprises a plurality of guides mounted on a jig base having a hole to receive the stop for storage.

16. The jig of claim 15, wherein the stop rod is flexible enough to insert it into a series of guides mounted on the jig base without removing the guides from the base but is stiff enough to provide a solid stop within each guide.

17. A jig comprising a jig base, a plurality of guides mounted on the base, at least two side registration surfaces on the base and in the same plane for contact with a side of a work-piece, and a spacer removably positionable either in contact with one of the at least two side registration surfaces or in a storage position on the base not in contact with any lateral registration surface.

18. The jig of claim 17, where the spacer is positionable in contact with one of the at least two side registration surfaces in at least either of:
a. a first orientation providing a first offset registration surface a first distance from the registration surface it contacts, or
b. a second orientation providing a second offset registration surface a second distance from the registration surface it contacts.

19. The jig of claim 18, wherein the spacer is temporarily positionable between guides to establish equal, predetermined spacing between the guides when positioning them in the jig for use.

20. A method for producing dovetail joint members, comprising:
a. providing a joint-making jig comprising:
i. a jig body,
ii. a plurality of guides:
1. positionable on the body laterally aligned and in side-to-side contact or in a plurality of spaced-apart positions, and
2. comprising two guide fingers on one end each of the guides and co-axial, lateral holes through the fingers, and
iii. two co-planar side registration surfaces attached to the body to facilitate positioning two joint member work-pieces on the jig,
b. positioning a plurality of the guides on the jig side-by-side with contact between adjacent ones of the positioned guides,
c. positioning a rod in the holes through the fingers of the plurality of guides positioned in contact side-by-side,
d. positioning a spacer against one of the two co-planar side registration surfaces,
e. positioning the two joint member work-pieces so that an end of one of the work-pieces overlaps an end of the other of the work-pieces and one of the two joint member work-pieces is in contact with one of the side registration surfaces and the other of the joint member work-pieces is in contact with the spacer, and
f. simultaneously cutting dovetail joint elements in each of the two work-pieces using an electric router guided by contact with the guide fingers and with the rod.
